(19) United States
(12) Patent Application Publication
(10) Pub. No.: US 2021/0134470 A1
(43) Pub. Date: May 6, 2021

(54) Method and Apparatus for Controlled Thermonuclear Fusion Power

(71) Applicant: JERRY I. JACOBSON, JUPITER, FL (US)

(72) Inventor: JERRY I. JACOBSON, JUPITER, FL (US)

(21) Appl. No.: 17/014,341

(22) Filed: Sep. 8, 2020

Related U.S. Application Data
(63) Continuation of application No. 15/806,687, filed on Nov. 8, 2017, now abandoned.
Application No. 15/806,687 is a continuation-in-part of application No. 15/470,181, filed on Mar. 27, 2017, now abandoned.

(51) Int. Cl. G21B 1/05; G21B 1/17; G21B 3/00; H05H 1/10; H05H 1/02; H05H 1/14

(52) U.S. Cl. CPC G21B 1/05; G21B 1/17; G21B 3/00; Y02E 30/10; H05H 1/02; H05H 1/14; H05H 1/10

(57) ABSTRACT

Ocean water and/or heavy water will be utilized as fuel to derive fusion energy. Utilizing multiple coiled, triple-axis systems, shall produce magnetic flux densities from 10⁻⁶ Gauss to 10⁻²¹ Gauss as derived from mc²=BvLq (Jacobson Resonance). Matter may be cajoled, such as deuterons and protons to fuse, thereby providing energy. This energy will be withdrawn for conversion of heat energy to electricity.

### RELATED APPLICATION

The present application is a continuation application of application Ser. No. 15/806,687, filed Nov. 8, 2017, entitled “Method and Apparatus for Controlled Thermonuclear Fusion Power,” which is a continuation-in-part application of application Ser. No. 15/470,181, filed on Mar. 27, 2017, entitled “Method and Apparatus for Controlled Thermonuclear Fusion Power Utilizing Extremely Low-Level Amplitude Modulated Magnetic Resonance to Overcome the Quantum Barrier by Manipulation of Dark Energy,” which are both hereby expressly incorporated by reference in their entireties.

### TECHNICAL FIELD

The present disclosure relates generally to an apparatus and method for generating electrical power; in particular, this disclosure relates to power generation through controlled thermonuclear fusion.

### BACKGROUND AND SUMMARY

Many groups have sought to replicate conditions in the sun where enormous amounts of energy are produced from the fusion of hydrogen atoms. Here on Earth, uncontrolled fusion is seen in the hydrogen bomb. Man has attempted to provide fusion power thus far through two methods, one being a brute force method, which has not worked, because conditions cannot be replicated on Earth as they are in the sun; and secondly, man has attempted to provide fusion power from systems at room temperature. These systems have thus far failed as well.

Deuterium gas can be produced through electrolysis by splitting heavy water molecules in which the hydrogen has been replaced by deuterium. When an electric current is run through the heavy water in a fusion cell, it triggers chemical reactions at the metal rods. Lithium deuteroxide (LiOD) can be added to the water to increase its ability to conduct electricity and speed up the process. At the palladium rod, the heavy water (D₂O) reacts with the electrons that make up the current to produce deuterium gas and deuterium oxide ions:

2D₂O (l)+2e⁻>D₂ (g)+2OD⁻ (aq)

At the platinum rod, the deuterium oxide ions react with each other to produce oxygen gas, water, and electrons:

4OD⁻ (aq)>O₂ (g)+2D₂O (l)+4e⁻

So in the net reaction, water decomposes into oxygen and deuterium gasses:

2D₂O (l)>O₂ (g)+2D₂ (g)

U.S. Pat. No. 5,198,181 for a “Stabilizing Plasma in Thermonuclear Fusion Reactions Using Resonant Low Level Electromagnetic Fields” issued Mar. 30, 1993, which is hereby incorporated by reference, discusses a technique wherein Jacobson Resonance magnetic coils encapsulate a Tokamak-type fusion test reactor in order to stabilize the deuterium ions in said system such that fusion may occur. It is supposed that the strong magnetic field utilized by Tokamak will interfere significantly with the very weak magnetic fields created by the external magnetic coils preventing the fusion reaction to provide ignition.

Controlled thermonuclear fusion power has been a significant concern since the 1950's. Magnetic confinement systems such as Tokamak, utilizing very strong magnetic fields and high temperature systems have failed to provide ignition of plasma. Laser systems such as SHEBA have also failed to provide controlled thermonuclear fusion power. Muon-catalysed fusion has not provided success. Various reports of room temperature fusion systems have denoted failure as well. Therefore, in consideration of the great need for an alternative to usage of fossil fuels is indicated most especially to provide electrical energy. The various current modalities providing energy will, in due course, be exhausted, except for such sources as solar, wind, and hydro sources which clearly will prove insufficient. Controlled thermonuclear fusion power is the logical choice for future generation of electrical energy, while using ordinary ocean water as fuel. To provide an economical basis for energy production, while producing little radioactive material, controlled fusion is no doubt the resource for future civilization.

The room temperature system provided by Pons and Fleischman did not account for ambient electromagnetic fields which may have induced a resonant response in deuterium nuclei which could have made the first experiment work fortuitously. The experiment did not yield neutron emission which was supposed to be necessary in terms of validating the system.

However, in embodiments of the present disclosure, the resonant response is controlled with the usage of formalized calculations enabling a successful production of ignition of the plasma contained within the interstices of the palladium electrode. In embodiments of the present disclosure, so-called fusion works, at least in part, because previous attempts did not consider the importance of environmental electromagnetic fields. Indeed, in order to provide fusion for man-kind, it is important to re-create the conditions under which a star is born, rather than conditions that cannot be replicated on Earth.

In some embodiments, the system and method utilizes a new equation that unifies gravity and electromagnetism based on the equation of Jacobson Resonance; thus, we may calculate the magnetic fields necessary to tune into hydrogen ions and coax them into fusing. These calculated magnetic fields correspond to measurements of outer space magnetic fields made by NASA in the range of about a trillionth of a gauss. The Earth's natural magnetic field is about a half of a gauss. What this means is that we can communicate with individual hydrogen atoms by using a very weak force because the atoms are so small. Strong forces simply push around large aggregations of atoms and cannot create the tunneling effect between the hydrogen atoms to overcome electrostatic repulsion. When we regulate the coherent and congruent vibrational states of the atoms and make them move together (relative translational motion) then we can overcome the oppositional forces of dark matter that create the quantum barrier. When the ions are close enough together, a strong nuclear force can take over at short distances to enable protons and/or deuterons to stick together when these ions, protons, and/or deuterons fuse, energy is liberated at levels greater than 20 times the energy put into the system. Reactions like these, (from four hydrogen atoms) are about 190,000 kilowatt hours, enough electrical energy to run a thousand-watt electrical appliance day and night for 20 years.

The amount of energy that can be drawn from ordinary ocean water can assure the energy source for future civilizations, for electricity, space travel, as well as cars. The simple solution is to use a system of resonance, the most general form of resonance, and is related to both magnetic resonance as well as cyclotron resonance. The value of this method and apparatus is currently inestimable, most especially because we are depleting the Earth of our fossil fuels. We have enough ocean water to last many millions of years. Essentially, by introducing the correct ambient magnetic field, based upon calculations, we can make a piece of metal sitting in ordinary ocean water, hot enough to produce 20 times more energy out than is put into the system.

Additional features and advantages of the disclosure will become apparent to those skilled in the art upon consideration of the following detailed description of the illustrated embodiment exemplifying the best mode of carrying out the disclosure as presently perceived. It is intended that all such additional features and advantages be included within this description and be within the scope of the disclosure.

### BRIEF DESCRIPTION OF THE DRAWINGS

The present disclosure will be described hereafter with reference to the attached drawings which are given as non-limiting examples only, in which:

FIG. 1 represents combination of solenoidal and poloidal coils creating three axes of Lorentz forces providing resonant magnetic flux densities for charged species contained by a vessel placed in the midst of the solenoid according to an embodiment of the disclosure.

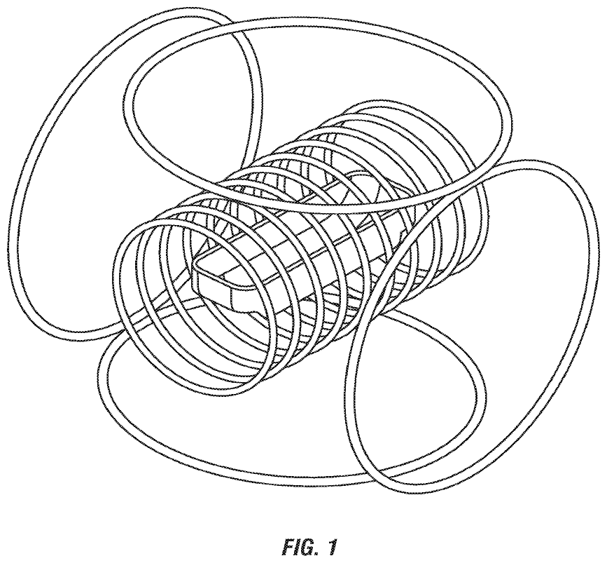

FIG. 2 represents a combination of solenoid and poloidal coils creating a double axis Lorentz form combination to induce fusions within the vessel containing ocean water according to an embodiment of the disclosure. An option for poloidal coils is to position them in a Helmholtz configuration.

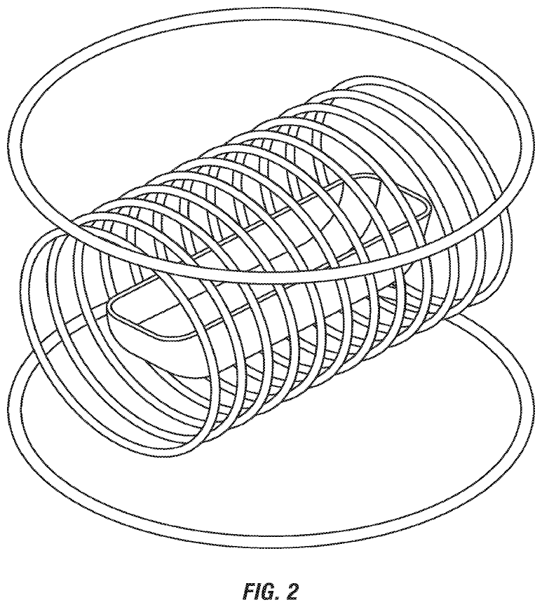

FIG. 3 represents a 6 coil system creating a triple axis orientation wherein the magnetic flux density may be homogeneous and isotopic, and electromagnetic fields are balanced and aligned according to time and magnitude according to an embodiment of the disclosure.

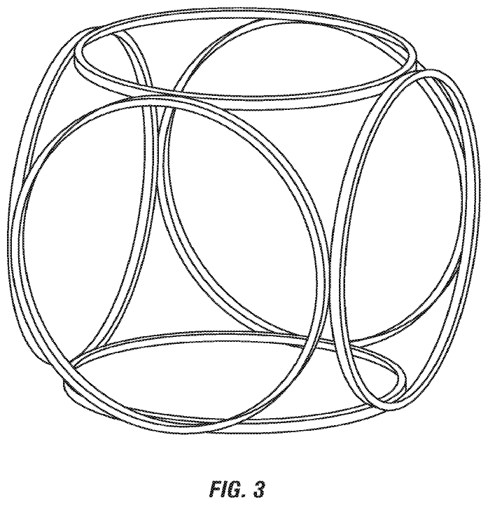

FIG. 4 represents a triple axis system wherein four coils are rectilinear and the central coil is solenoidal to therein contain the insulating vessel holding ocean water in its midst according to an embodiment of the disclosure.

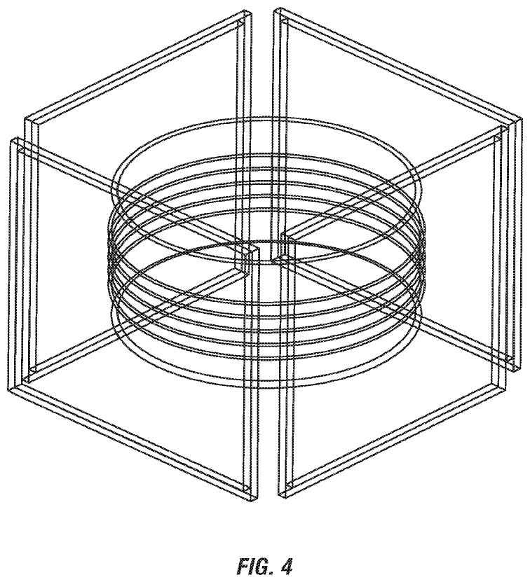

FIG. 5 represents the usage of plates in lieu of coils in addition to a solenoidal system in the center creating once again, a triple axis vector field for fusion according to an embodiment of the disclosure.

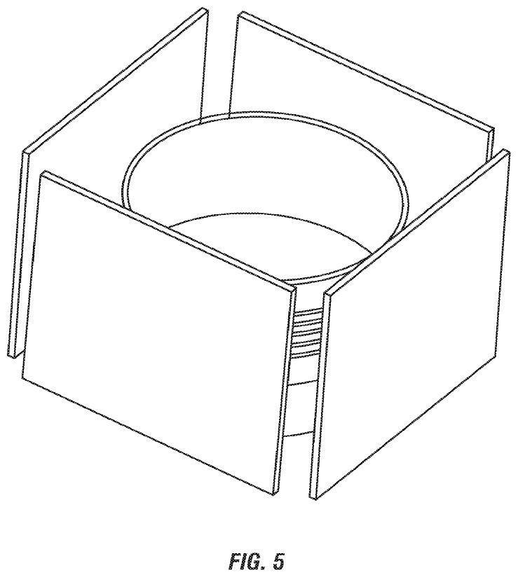

FIG. 6 represents usage of multiple and varying size coils to concentrate magnetic field lines in a particular direction; whereas this approach may be utilized in a single axis, double axis, or triple axis system according to an embodiment of the disclosure.

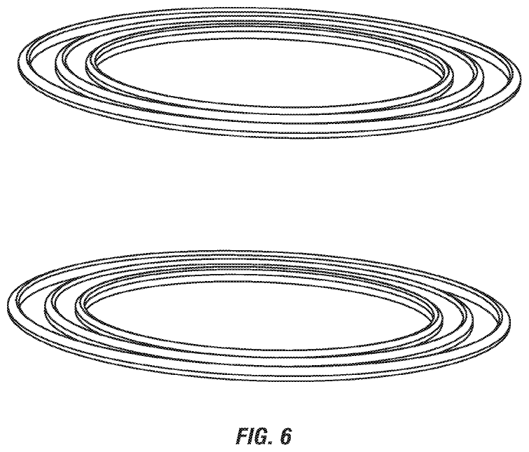

FIGS. 7-9 represents directional rotation of particulate masses according to an embodiment of the disclosure.

FIG. 10 is a schematic representation of an example fusion apparatus according to an embodiment of the disclosure.

The drawings provide examples of various coil and plate designs for creation of magnetic fields may include combinations of poloidal coils in conjunction with solenoidal coils. The combinations thereto may provide magnetic fields that are homogeneous and isotropic in one, two, three, or more directions in order to regulate the inertial states of particulate matter for fusion power. The components in the figures are not necessarily to scale, emphasis instead being placed upon illustrating the principles of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

Jacobson Resonance delineates mass as (m). The deuteron is an example of such a mass as may be applicative to the Jacobson Resonance calculation. Mc^{g} provides the intrinsic energy of the ion. BvLq represents the EM interaction energy, emitted as a wave. The wave connects to the dark energy of space. Dark energy is the collection of masses vibrating in ordered patterns through ordinary matter. Although dark matter does not actually touch ordinary mass, the connection remains as a singularity. There is a conversion of EM wave via gravity wave to dark energy with communication to form a phonon (quantized vibration) in the field of ordinary matter. The velocity (v) is an inertial velocity (of constant velocity motion), such as Earth's orbital velocity, solar system velocity, local star cluster velocity . . . etc. Earth's orbital velocity is about 3×10⁶ cm per second.

The (L) is the longest dimension of the electrode and or/the vessel containing ocean water. Q is a single unit of electric charge in CGS, i.e. the ab coulomb.

$$B = \frac{m}{q T}$$

by definition as derived from the magnetic component of the Lorentz force equation. The units are now seen:

$$\frac{{mass ( distance )}^{2}}{{time}^{2}} = ( \frac{mass}{unit charge . time} ) ( \frac{distance}{time} ) ( distance ) ( unit charge )$$

The magnetic field B with very low frequency, below 1 Hertz, will reorient dark energy to promulgate an electromechanical transduction. The deuterons will overcome the quantum barrier through subtle forces as opposed to brute force, as seen in the Tokamak Test Fusion Reactor or the SHEBA utilizing lasers and extremely high temperatures. Cajolement as opposed to brute force is the essential underpinning mechanism for universal design.

### Dark Energy

Dark matter contains other states of reality as described in part by Kalusa Klein Theory. The number of dimensions is not actually known. When one equates the term “dimension” with “other states of reality” it is erroneous to equate the term dimension with the possible multitudinous other states of reality. It is more accurate to describe dark energy/dark matter in terms of a four dimensional continuum as existent in other states of reality or coordinate systems of reference. It is important to note that the negative electrode, e.g. palladium will have micropores and/or microtrebeculae which shall encapsulate lacunae. Whereas, controlled thermonuclear fusion energy shall be liberated secondary to fusion of deuterium ions and/or protons, therein cajoled to fuse as a consequence of coherent vibrational states induced in dark matter, i.e. interstitial matter comprising other states of reality (dark energy). Dark matter and dark energy are herein equatable in principle, because a particular distinction for other states of reality is a moot point in this regard. Electrons are also tuned by Jacobson Resonance; indeed, all subatomic particles known may prove useful as target masses, e.g. neutrinos that are smaller than electrons perhaps by a factor of about 10⁴ to 10⁵. Target masses such as muons or tau force carriers may be utilized as target masses. The physical definitions of units are thus proposed to discover dark energy and its relation to ordinary matter.

Hidden Interstitial Mass: Dark Energy

We shall initially set aside vector analysis, and consideration of supplementary units, i.e. plane and solid angles, while including as needed derived units with special names. We view the following line of reasoning from a base unitary perspective, keeping in mind Einstein's final concern that an attempt must be made to find a purely algebraic theory for the description of reality. [6]

From the magnetic component of Lorentz force equation, we consider

$$B = \frac{F}{qv sin ϕ} ( \frac{Newton}{coulomb meter / sec} ) \qquad ( 1 )$$

### In MKS, and

$$B = \frac{F}{qv sin ϕ} ( \frac{dyne}{ab \text{-} coulomb centimeter / sec} ) \qquad ( 2 )$$

In CGS, and

Denoting magnetic flux by,

$$ϕ , B = \frac{ϕ}{A} ( \frac{weber}{{meter}^{2}} ) ,$$

where in MKS units

$$1 Tesla = \frac{1 weber}{{meter}^{2}} = \frac{1 Newton}{coulomb meter \text{/} sec} = \frac{1 Newton}{amp \cdot meter} where in MKS units , \qquad ( 4 )$$

And in CGS units,

$$\begin{matrix}1 gauss = \frac{1 max well}{{cm}^{2}} & ( 5 ) \\ And \frac{1 weber}{{m}^{2}} = {10}^{4} gauss & ( 6 )\end{matrix}$$

1 Newton is defined as the force that provides a mass of one kilogram with an acceleration of one meter per second per second.

### Thus,

$$\begin{matrix}1 Tesla = \frac{\frac{kg \cdot m}{{sec}^{2}}}{\frac{coulomb \cdot m}{sec}} = \frac{kg \cdot m \cdot sec}{{sec}^{2} coulomb \cdot m} & ( 7 ) \\ 1 Tesla = \frac{kg}{coulomb \cdot sec} = {10}^{4} gauss & ( 8 )\end{matrix}$$

### And,

$$1 gauss = \frac{gm \cdot cm \cdot sec}{{sec}^{2} \cdot ab - coulomb \cdot cm} = \frac{g}{ab - coulomb \cdot sec .} \qquad ( 9 )$$

As denoted by Eqs. (8) and (9), the flux density B represents

$$\frac{mass}{( charge \cdot time )}$$

Since charge is a property of certain elementary particles, by definition, that causes them to exert forces upon one another, and the force is thought to result from the exchange of photons between said particles; charge is a function of certain masses as observed in nature. The coulomb corresponds to a charge of 6.25×10¹⁸ electrons. Since reality reduces to matter and motion/interaction of matter, (mass/distance/time) we may write:

$$\begin{matrix}1 coulomb = 6.25 \times {10}^{18} electrons \cdot mass \\ of e ( 9.1095 \times {10}^{- 31} kg ) & ( 10 ) \\ Thus , 1 coulomb = 5.6934375 \times {10}^{- 12} kg Since 1 Tesla = 1 kg / 5.6934375 \times {10}^{- 12} kg \cdot sec , \\ \frac{1 Tesla = 1.756408 \times {10}^{11} kg ( invisible mass )}{1 kg ( visible mass ) \cdot sec} \\ and & ( 11 ) \\ \frac{1 Gauss = 1.756408 \times {10}^{7} gm ( invisible mass )}{1 gm ( visible mass ) \cdot sec} & ( 12 )\end{matrix}$$

The single conventional magnetic line of force in a vacuum carries about seventeen and a half million grams of unseen matter every second through a mass of ordinary matter of one gram. It is clear that a material substance fills all of space, and this is evidenced by definition of conventionally utilized physical units, and the perception that gravity exists everywhere in the universe.

It is evident that the combination of very light nuclei to form heavier ones results in an increase in binding energy per nucleon. Since it results in a more stable nucleus, it is known that such a reaction will release a large amount of energy.

The amount of energy equivalent to the difference between the combined masses of four hydrogen atoms (or a combination of two deuterium atoms), to create one helium atom is about 28.3 Mev or about 4.53×10⁻¹² joule. In this regard, we note that the combination of 4 protons may create 1 helium nucleus+2 positions and energy. The interaction of positrons and electrons to produce mutual annihilation will result in the production of Gamma Rays. For every proton used in this reaction then, 1.13×10⁻¹² joule of energy will be released. Each gram of protons involved in this sample reaction will release about 6.8×10⁻¹² joule of energy. If this were converted into electrical energy, we would have 190,000 kilowatt-hours from the reaction of about 1 gram of protons, enough to operate a 1000 watt appliance continuously, day and night, for more than twenty years.

Let us take for example a mass of 4×10⁻²⁶ grams, the mass of a meson, let the distance be equal to r. As per Coulomb's law, electrostatic force is given by e²/r² wherein e is 4.77×10¹⁰ esu, i.e. elementary electric charge. As per Newton's law, gravitational interaction is given by

$$\frac{{GM}^{2}}{{r}^{2}}$$

where G (6.67×10-8) is the gravitational constant and M (4×10⁻²⁶ gm) is the intermediate mass. The critical elemental question is, “Why is the ratio of the two forces

$$\frac{{e}^{2}}{{GM}^{2}} ;$$

whereas this ratio is equal to 10⁴⁰?” This differential may be explained by recalling the definition of a gauss, wherein 1 gauss is about equal to 1.75×10⁷ grams of invisible mass, divided by a single gram of visible or ordinary mass×1 second. If we mathematically cancel the unitary masses, a single gauss may be expressed as a frequency (f). This frequency of 1.75×10⁷ Hertz may be introduced into the formula: energy=Plank's constant×Frequency, or E=hf.

Planck's constant is about 6.626×10⁻²⁷ erg·sec when f=1.75×10⁷ Hertz, E is about 1.16×10⁻¹⁹ ergs. Utilizing e=mc², we find that 1.16×10⁻¹⁹ ergs divided by c² equals about 1.29×10⁻⁴⁰ gram. Thus accounting for the differential between ordinary mass and the substructures that comprise the gravitational field. The differential is 10⁴⁰ because ordinary mass per gram may be relatable to the essential underpinning substructure of gravity at 10⁻⁴⁰ grams. The particles that comprise the gravitational field are in general 10⁴⁰ times smaller than the particles responsible for the electric force. The differential relates unit mass regarding electromagnetic field and the ultimate unit mass of gravitational field, perhaps spin-2 gravitons. The substrates of dark energy are elementally small but combine to form other states of reality in such a manner so as to avoid direct touching of the ordinary four dimensional field of matter, i.e., external field.

### The Derivation

As a joint result of the motion of charge and the magnetic field every charge in a conductive body experiences, a Lorentz force. Representing the magnetic component, we desire in non-vector notation,

F=qvB sin θ (1)

Where F is force, q is charge, v is velocity, and B is magnetic flux density. Eq (1) assumes that vectors v and B are perpendicular. The force acts in a direction that is perpendicular to both the direction of motion and the magnetic field; whereas θ is the angle that the direction of motion of the particle makes with the magnetic field. If a body is being accelerated, there is a resultant force acting on the body. If the acceleration (of the center of a uniform body) is given by a vector [symbol] and the resultant force on the body is given by a vector [symbol] , Newton's Second Law states that,

F= [symbol] (2)

Combining eqs. (1) and (2) maintaining unitary conformance, and setting aside vector notation, we discern,

$$F = ma = qvB = ( q ) ( \frac{L}{t} ) ( \frac{m}{q t} ) = \frac{m L}{{t}^{2}} \qquad ( 3 )$$

Where B=m/qt, t is time, and L is distance.

The electric potential energy per unit test charge is customarily called the electric potential, ϕ, or the voltage, V. (We shall now use the former term; in circuit applications, the latter is employed). Since ϕ=U/q (where U is electric potential energy), and E_{F} (electric field strength), F/q, ϕ and EF enjoy the same relation as U and F:

$$\begin{matrix}ϕ ( x , y , z ) = - {\int }_{∞}^{( x , y , z )} {E}_{F} \cdot ds = - {\int }_{∞}^{( x , y , z )} {E}_{Fx} dx + {E}_{Fx} dy + {E}_{Fz} dz ( V ) & ( 4 ) \\ {E}_{F} = - ( \frac{\partial ϕ}{\partial x} i + \frac{\partial ϕ}{\partial y} j + \frac{\partial ϕ}{\partial z} k ) ( V \text{/} m ) & ( 5 )\end{matrix}$$

The unit of electric potential is the volt (V), where 1 V=1 J/C. Also, 1 V/m=1 N/C.
Generalizing, if there exists a charge q at a point, and there is an electrostatic force F acting on the charge, due to other charges around, the electric field E_{F} at the point is defined as

$${E}_{F} = \frac{F}{q} \qquad ( 6 )$$

For the purpose of nomenclature, we shall henceforth denote electric field strength as E_{F} and energy will be represented by E. Furthermore, electric potential V at a point in an electric field is the work required to bring unit electric charge from infinity to the point. It is measured in volts. If work of one joule is required to move a charge of one coulomb to the point, its potential is one volt.

The strength of an electric field E_{F} is also given by

$${E}_{F} = \frac{V}{L} \qquad ( 7 )$$

And, it is duly noted,

$$V = \frac{E}{q} \qquad ( 8 )$$

Combining Eqs. (6), (7), and (8), setting aside vector analysis, we derive

$$F = {qE}_{F} = \frac{qV}{L} = \frac{qE}{qL} = \frac{E}{L} = qvB \qquad ( 9 )$$

Concerned only with qualitative fundamental unitary measures, we desire

E=qvBL (10)

Wherein q v B L represents a resonant electromagnetic interaction energy, as we shall soon see. We note Einstein's law, the law of the equivalence of mass and energy in generic form

E=mc² (11)

Where c is the velocity of light in vacuo. Thus, a quantity of energy E has a mass m, and a mass m has intrinsic energy E.
Then, from Eqs. (9) (10) and (11),

$$E = {mc}^{2} = F \times L = \frac{{mL}^{2}}{{t}^{2}} = qvBL \qquad ( 12 )$$

From Eq. (8) we note,

E=qV (13)

Now, recapitulating,

$${E}_{F} = \frac{V}{L} = \frac{E}{q L} = \frac{F x L}{q L} = \frac{F}{q} = \frac{q v B}{q} = v B \qquad ( 14 )$$

And, from Eq. (3) we noted

$$B = \frac{m}{q t} \qquad ( 15 )$$

Therefore, from Eqs. (14) and (15)

$$\frac{m v}{q t} = vB = \frac{E}{q L} = {E}_{F} \qquad ( 16 )$$

With Eq. (10) rearranged, and from Eq. (16) we see

E=vBqL (17)

Thus from a qualitative foundational unitary perspective, we may now consider rearranging Eq (17), and we see

$$E = m {c}^{2} = BvLq = \frac{m {L}^{2}}{{t}^{2}} = ( \frac{m}{q t} ) ( \frac{L}{t} ) ( L ) ( q ) \qquad ( 18 )$$

Electromotive force Vi is the algebraic sum of the potential difference acting in a circuit. It is measured by the energy liberated when unit electric charge passes completely round the circuit in the direction of the resultant emf. An agent such as a battery or generator has an electromotive force (emf) if it does work on the charge moving through it, the charge receiving electrical energy as it moves from the lower to the higher potential side.

Emf is measured by the potential difference (p.d.) between the terminals when a battery or generator is not delivering current. The units of emf are the same as the units of p.d. since both are measured by work per unit charge. If a battery sends a current I through an external resistance R joining its terminals, the emf of the battery is equal to (R+b) I, where b is the internal resistance of the battery. It is thought that while the term emf is sometimes used as equivalent to potential difference, strictly speaking it should be applied only to a source of electric energy. However, in consideration of the fact that we are concerned with unifying the forces of electricity, magnetism and gravity, we must consider that electric energy may be converted to magnetic energy, and to gravitational energy; because energy is defined as mass times distance squared over time squared. Essentially, we are denoting that all material interactions are a product of the conceptual substrates: mass, distance and time. Further to this end, we view all living systems as complex homeostatic arrays of biologically closed electric circuits. (21).

Hence, we desire:

$${V}_{i} = \frac{E}{q} \qquad ( 19 a )$$

Where Vi is induced electromotive force (emf). The emf Vᵢ, induced in a straight conductor of length L moving with velocity v perpendicular to a field of magnetic induction B is

Vᵢ=BvL (19b)

The emf Vᵢ is in volts when B is in Webers/m²

Now, L is the length of a body; wherein all ordinary material bodies are essentially condensations of electromagnetic field, and have a longest dimension (5,7).

Whereas B, v and L are orthogonal and accepting the unitary equivalencies, we see from Eqs. (14) and (19 a,b)

$${V}_{i} = \frac{E}{q} = B v L \qquad ( 20 )$$

q
Where q is unit charge by definition.
Therefore, we may reiterate the finding in Eqs. (18) and (20) as

$$E = BvLq = m {c}^{2} = \frac{m {L}^{2}}{{t}^{2}} \qquad ( 21 )$$

Furthermore, we desire,

E=hf=mc²

Where E is energy, h is Planck's constant (defined as mc²t), f

is frequency, m is mass and c is the velocity of light.

### Note,

c=λf (23)

Where λ is wavelength, and f=c/λ,

### Therefore,

$$m {c}^{2} = \frac{h c}{λ} \qquad ( 24 )$$

### Dividing by c, we get:

$$m c = \frac{h}{λ} \qquad ( 25 )$$

Where Eq. 25 is de Broglie's particle-wave equation. Generalizing, c=v, we desire,

$$mv = \frac{h}{λ} \qquad ( 26 )$$

It is of particular interest to place equations (22) to (26) into historical perspective. Einstein's theory proposed that for any electromagnetic wave of frequency f there is photonic energy, E=hf. The de Broglie hypothesis of light-matter symmetry required that all material particles have a wave associated with them. Utilizing the equations of relativity, de Broglie provided a formula relating wavelength to the mass and speed of the particle.

Since the energy of a photon is related to frequency f of an associated light-wave by, E=hf, and photons also possess momentum p, according to E=pc, he then derived,

$$E = p c = h f = \frac{h c}{λ} \qquad ( 26.1 )$$

### Therefore,

$$\begin{matrix}P = \frac{h}{λ} \\ Or & ( 26.2 ) \\ λ = \frac{h}{p} & ( 26.3 )\end{matrix}$$

Eq. (26.3) was derived specifically for the photon, considered a massless particle associated with a light-wave. However, de Broglie proposed that Eq. (26.3) applied to any particle, massless or not. (Actually, it is a simple matter to show that a photon is not massless, combining E=hf and E=mc² because a quantity of energy has a mass m, and a mass m has intrinsic energy E).

The momentum of a particle of mass m and speed v is p=mv. Therefore, Eq. (26.3) becomes

$$λ = \frac{h}{m v} \qquad ( 26.4 )$$

Whereas, Eq. (26.4) gives the wavelength λ of the de Broglie wave associated with a particle of a given mass and speed. He then had two equations, E=hf and P=h/λ, that related particle properties (energy and momentum) to wave properties (frequency and wavelength). These equations applied equally to particles such as electrons, atoms . . . etc. as well as to photons. Material particles and photons equally obeyed the relativistic equation, E²=p²c²+m₀² c⁴, the distinction being that m₀=0 for photons. Yet, both photons and material particles had associated de Broglie waves.

Eq. (26.4) is relativistically correct when m represents the relativistic mass, rather than the rest mass m0.

m=m₀/\sqrt{1−}V²/c²

Where the rest mass m₀ can be used if the speed v is small compared to c.

The de Broglie wave of a photon is a light wave and travels at speed c, whereas speeds of waves associated with particles having mass depend on the speed of the particle. De Broglie maintained that his theory should be considered as a formal structure, and a fully formed unified doctrine. He made an especially interesting application of this principle with respect to electron orbits in the atom. An electron travels in a circular orbit about the nucleus. Assuming an electron is guided in its orbit by a de Broglie wave, if it catches up with itself, then interference must be the result. To avoid cancellation of the wave, it must be in phase with itself. De Broglie' s conclusion was that a standing wave pattern must be established. The circumference of the orbit must then be equal to an exact number of wavelengths. It must be possible to fit exactly one, or two, or three, waves around the orbit. Fractions of waves would necessarily cause cancellation. The requirement was written mathematically as follows:

nλ=2πr (n=1,2,3 . . . ∞) (26.6)

Where n is an integer, λ is de Broglie wavelength, and 2πr is the circumference of the orbit with radius r; and we note

$$n λ = n ( \frac{h}{m v} ) = 2 π r \qquad ( 26.7 )$$

Eq. (26.7) can be rearranged as follows:

$$mvr = \frac{n h}{2 π} ( n = 1 , 2 , 3 \text{...} ∞ ) \qquad ( 26.8 )$$

Eq. (26.8) represents Bohr's assumption of the quantization of angular momentum (mvr), which he utilized to obtain allowable orbits and energy levels of the hydrogen atom. Now, we extend our purview from atomic orbitals to the particles themselves. Instead of describing quarks, neutrinos, electrons, and other fundamental particles as points, string theory describes them as lines—very small, wriggling lines. Superstring theory yields a finite quantum theory of gravity, and it requires gravity for consistency.

In 1970, Yoshiro Nambu pointed out that the Dual Resonance Model was mathematically equivalent to interactions of bits of string. Originally, it was a simple formula describing hadron scattering. He pictured the particles as tiny strings about 10⁻¹³ cm long (the size of a proton). When two strings touched their tips together, they fused together into one, or conversely, one string could spontaneously split into two.

Regarding a collision, strings could absorb energy to ripple and rotate, with ends flashing about at the speed of light. In 1976, Scherk maintained that string models could represent fermions (including baryons and leptons) if fermions were matched with correspondent bosons; called for by supersymmetry. In gauge interactions, qualities like hypercharge or color could be carried by the tips of strings.

Calculations have shown that when interacting strings are in their lowest energy state; the transfer of quantum numbers is equivalent to the exchange of “massless” spin-1 particles (photons).

Furthermore, a single string can touch its own ends together and fuse into a loop; and the lowest energy state of a closed string would be “massless”, and have a spin of 2. A “massless” spin-2 particle may be equivalent to a quantized gravity wave, or graviton.

If this theory of quantum gravity is correct, then the scale of a fundamental string could be set by Planck energy. The Planck scale translates into a string about 10⁻³³ cm long, twenty orders of magnitude smaller than a proton; accounting for the fact that quarks, neutrinos and such small particles appear as infinitesimal points; and also having a lowest energy excited state about 10⁻¹⁹ times the mass of a proton.

From the idea of a relativistic quantum string, one may possibly derive a theory free of “anomalies” and “infinities,” a specification of the symmetry group of grand unification, supersymmetry, and a unification of the strong, weak and electromagnetic forces with quantum gravity.

The issue still at hand is for superstring theory to make contact with the real world. (22,23)

Now, we desire,

λ=2πL (27)

Where λ is wavelength (the circumference of a loop of string), and L is its radius. From Eqs. (26) and (27) we see,

$$mv = \frac{h}{2 π L} \qquad ( 28 )$$

### Rearranging,

$$v L = \frac{h}{2 π m} \qquad ( 29 )$$

When both sides of Eq. (29) are multiplied by charge (q) and magnetic flux density (B), we derive,

$$BvLq = \frac{q h B}{2 π m} = {mc}^{2} \qquad ( 30 )$$

Where qhB/2πm is the Zeeman (magnetic resonance) term for energy.
Since h is mc²t, we see:

$$\begin{matrix}{mc}^{2} = \frac{{gmc}^{2} tB}{2 π m} & ( 31 ) \\ And , & \\ \frac{I}{t} = f = \frac{qB}{2 π m} & ( 32 )\end{matrix}$$

Where Eq. 32 represents cyclotron resonance. Now, since no emf is perceived when a body is at rest (v=0) in a steady or unchanging magnetic field, we herein propose that a gravity wave is nevertheless promulgated, because any body at rest (v=0) on Earth is still moving with its celestial frame of reference in constant velocity motion, e.g. Earth's orbital velocity; whereas the force carriers (photons) of a magnetic field move at the velocity of light, independent of their source, and its state of motion. The laws for a body at rest and a body in constant velocity motion, e.g. Earth's orbital velocity, are the same; and a body at rest on Earth (v=0) is moving with constant velocity motion (with the Earth). Newton did not distinguish between terrestrial velocity and celestial velocity, as did Aristotle. Therefore, in mc²=Bvlq, (Jacobson Resonance) the intrinsic energy of a particle, when equal to the wave energy of a body of length (L) interacting with a magnetic field (B), and wherein the body (L) contains the particle (m), a coherent excitation is produced in (m).

If space is filled with an infinite sea of energy; as gravity is everywhere omnipresent, and gravitational field may also be designated as space (5,6), then mc²=BvLq represents inertial electromagnetic induction of resonant coherent vibrational amplifications in (m). This is based in quantum gravitational communication, i.e. a gravity wave (lossless and independent of thermal noise in the environment). It is the case when a body is at rest (v=0) or is in motion, and when said body is immersed in a steady or changing magnetic field.

There must be induction and promulgation of a gravity wave, so long as there is no such thing as absolutely empty space (6).

The force carriers of a magnetic field, i.e. photons, move at the velocity of light, independent of their inertial frame of reference, i.e. the propitiating source of magnetic field production, and transmission of force (pressure wave of deforming or reforming character). (7,8) Quantum mechanical view of the quantum vacuum supports this contention (6) and experimental validation has been based upon the following sample calculation (among numerous others).

### Sample Calculation and Studies

Nerve growth factor (NGF) exhibits trophic influences on a variety of neuronal populations; promoting survivability, regulation of synaptic transmissions, and plasticity at adult synapses in many regions of the central nervous system; and homeostatic regulation of intrinsic neuronal excitability. NGF contains an anti-apoptosis inducing segment to prevent cell death. Choosing NGF as a target, we consider the following:

(1) NGF is 26,500 Dalton, or 4.425×10⁻²⁰ gram

(2) C²=9×10²⁰ cm² sec⁻²

(3) (L) is the height of a human, or 177 cm.

(4) (V) is Earth orbital velocity, or 3×10⁶ cm sec⁻¹

(5) (q) is one ab-coulomb (unit charge by definition)

The CGS system of physical units is chosen, because, in the MKS (SI) system force is determined between moving charges, whereas in the CGS system force is determined between stationary charges. Therefore, we desire:

Mc²=BvLq

(4.425×10⁻²⁰ gm)(9×10²⁰ cm² sec⁻²)=(7.5×10⁻⁸ Gauss)(3×10⁶ cm sec⁻¹)(177 cm)(ab-coulomb) (33)

Then, we note that (q) is normalized in CGS. Consequently, when converting from CGS to MKS, mc²=BvLq becomes mc²=BvL (10 q), because 1 ab-coulomb is equal to 10 coulomb. Therefore, when using the MKS expression, f=qB/2 27 cm, we must use f=10 qB/2 2πm, and we note:

$$f = \frac{10 ( 1.6 \times {10}^{- 20} ab - coul ) 7.5 \times {10}^{- 8} Gauss )}{( 6.2832 ) ( 9.11 \times {10}^{- 28} gm )} = 2.1 Hz \qquad ( 34 )$$

Where, (q) is the charge of an electron and (m) is its mass.

Normalization permits the process of introducing a numerical factor into an equation and is of importance in quantum mechanics. Furthermore, the signal, 7.5 picoTesla at 2.1 Hz, has been successfully utilized in the treatment of Parkinson's Disease.

Pursuant to our thesis, we note the following expressions in CGS derived from mc²=BvLq; defining elements for the unification of matter and space.

$$\frac{\vec{{m}_{0} c} \cdot c}{\sqrt{1 - \frac{{v}^{2}}{{c}^{2}}}} = ( \vec{B} \times \vec{V} ) \cdot \vec{L} ( {q}_{1} )$$

$$\frac{- c}{( \sqrt{1 - \frac{{v}^{2}}{{c}^{2}}} ) {q}_{j} υ} \cdot ∮ {mcL}^{- 2} \cdot DL = \\ = ( \frac{\partial {A}_{3}}{\partial y} - \frac{\partial {A}_{2}}{\partial z} ) i + ( \frac{\partial {A}_{1}}{\partial z} - \frac{\partial {A}_{2}}{\partial x} ) j + ( \frac{\partial {A}_{2}}{\partial x} - \frac{\partial {A}_{1}}{\partial y} ) k = curlA = ( \vec{v} \times \vec{A} ) = \vec{∇} \times ∮ \frac{\vec{j \partial S} \vec{\partial L}}{r}$$

Where \vec{A} is the magnetic vector potential, and qⱼ is one ab-coulomb (normalized). Relativistic adjustment of mass is annotated, and current is given in ab-amperes, while (v) represents the inertial velocity, e.g. Earth's orbital velocity. I would urge the young eager minds of this new generation to examine the probability that mc²=BvLq drops out of string theory.

Remember, numerical assignments to unitary measures depend upon the physical model of reference, because the relativity of mass, distance and time is dependent upon the coordinate system of reference chosen consistently. The basic universal field of deepest reality, or purest essence, would no doubt include dark matter and dark energy, of which we currently know very little, besides their necessary existence.

Indeed, the subtle energies in the pico-Tesla range, measured in association with brain waves and the human heart, by superconducting quantum interference devices or atomic magnetometers, in our opinion, are manifestations of physiologic processes at sub-atomic and atomic levels; pointing to the existence of micro gravitational quantum interactions; undergoing incessant fluctuations required to maintain order in what has been thought to be chaotic models.

Finally, mc²=BvLq, may account for quantum tunneling, the phenomenon necessary for overcoming the quantum barrier, and producing thermonuclear fusion energy.

Black Space Matter (Dark Matter/Dark Energy/Invisible Matter)

Assuming

$$\frac{m}{qt}$$

that yielded

$$\frac{m}{mt}$$

is considered a frequency, i.e., 1.75×10⁷ sec⁻¹, we desire,

E=(6.626×10⁻²⁷ erg. Sec)(1.75×10⁷ sec⁻¹=hf=11.955×10⁻²⁰ erg=1.196×10⁻¹⁹ erg

### Then,

E=mc², and we note:

$$\frac{1.196 \times {10}^{- 19} ergs}{9 \times {10}^{20} {cm}^{2} {sec}^{- 2}} = m$$

And,

M≈0.133×10⁻³⁹ gm, and

M≈1.33×10⁻⁴⁰ gm

The gravitational force is about 10⁴⁰ times weaker than electromagnetic force. This would presume that while photons carry EM force, gravitons carry magnetic force qua magnetic force. This solves an age-old problem.

It is especially interesting to note that Rene Descartes considered our planetary orbit to be a result of Earth's vortical motion to be a result of a ethereal liquid vortex. Thus, the ratio of the mass of a graviton to the mass of a unit electrical charge is 10⁻⁴⁰.

### Sample Calculation

(2)(1.67×10⁻²⁴ gm)C²=mc²

(B)(3×10⁶ cm sec⁻¹)(10 cm)q=BvLq,

Where m is the mass of a deuteron, and mc^{g} then equals BvLq.
B˜10⁻¹⁰ Gauss when L is 20 cm, the B is ˜5×10⁻¹¹ Gauss.
When the conductor (palladium cathode in a system of electrolysis) is only 10 cm for experimental purposes. Then, the derived (B) field is inserted into

$$f = \frac{10 q B}{2 π m}$$

We note,

$$f = \frac{( 10 ) ( 1.6 \times {10}^{- 20} ab coul ( B )}{2 π ( 9.11 \times {10}^{- 28} gm )}$$

As B is derived from mc²=BvLq. In

$$f = \frac{( 10 ) qB}{2 π m}$$

m may represent a different charged particle, e.g a quark.
When B is ˜5×10⁻¹¹ Gauss, (as L equals 20 cm), the f˜1.33×10⁻³ Hz, m may represent a different charged particle, e.g. a quark

The most efficacious outcome is yielded by (B) fields lower than 10⁻¹⁰ Gauss for small studies. It appears that frequencies are low as 0.0001 Hz. The (B) field is relatively steady for small models. All components must be nonferrous materials such as glass or plastic. The environment should be entirely clean from ferrous metals.

Another possibility includes protonic resonance at about:

### e.g B=⁻¹° Gauss

### Thus,

$$f = \frac{( 10 ) ( 1.6 \times {10}^{- 20} ab - C ( {10}^{- 11} G )}{6.2832 ( 1.67 \times {10}^{- 24} gm )}$$

$$f ≅ 2.65 \times {10}^{- 6} Hz$$

The foregoing indicates a DC field.
Therefore, amplitude modulation is indicated for nuclear fusion.

We note that it is imperative to establish coherent and congruent oscillatory trajectories for vibrational ionic resultant to cajole deuterons and/or protons to overcome electrostatic repulsion thus overcoming the quantum barrier. When the ions are close enough to one another gravity will attract the ions and oppositional flow of dark energy will become moot. It must be noted that when coils are utilized for a single axis, it may be necessary to use opposite flow of electrons in the coils to stabilize the positions of ions in spacetime, e.g (N is north) N→S in one coil (S is south) and S→N in the other. It is also possible to utilize electron flows in coils that are existent in like directionality to provide relative translational motion of ionic vibrational modes. Similarly, 4 coils or 6 coil systems may utilize analogous methods, i.e. the same or opposite electron flows in the poloidal/solenoidal . . . etc. systems surrounding the vessel containing the ocean water and electrodes.

Of course ionic vector(velocity) is irregular and Lorentz forces may be opposite to that required. Thus, it may also be necessary to utilize AC field to induce a pulsating vibrational mode. The foregoing are simply illustrative of possible interactions. AC fields may be extremely low frequency, e.g. less than 1,000 Hz. But, higher frequencies may be utilized. Electric currents in coils are in phase, i.e. the same or opposite polar conditions to provide pulsating ions to provide quantum tunneling.

Two Coil Example: Currents in phase (same polar coordinates) using opposite current orientations also can provide appropriate interactions. Same or opposite polar coordinates may produce overcoming quantum barriers due to random disposition of charges.

However, if the magnetic fields are oriented to provide FQHE (Fractional Quantum Hall Effects) the charges may be piled up and created first to assemble at the edges of the electrode, rendering them more predisposed to affectation; including the production of quesi-particles with fractional electric charges. Thus, directionality of charge orientation is regulable and magnetic field are more calculable.

For small electrode models resonating electrons we note about 3×10⁻¹⁵ Gauss is indicated. For larger models about 10⁻¹⁶ to 10⁻¹⁸ Gauss (B) fields may be indicated. When neutrino masses are targeted for small model electrode systems, about 10⁻¹⁸ Gauss to about 10⁻²⁰ Gauss systems may be indicated. For larger electrode systems, about 10⁻²¹ Gauss (B) fields are indicated for targeting neutrino masses. Below 10⁻²¹′21 Gauss (B) fields may be utilized for targeting dark energy targetable masses.

For a larger electrode system, L=3.0 cm utilized in the foregoing example, using electron resonance we see:

(9.11×10⁻²⁸ gm)(9×10²⁰ cm² sec⁻²)=mc²

Then,

(B)(3×10⁶ cm sec⁻¹)(30 cm)(1 ab-c)=BvLq

About 9×10⁻¹⁵ Gauss=B˜10⁻¹⁴ Gauss. We note that Neutrino mass about 10⁻⁵× the mass of an electron, requiring flux densities of lower magnitude. B˜10⁻¹⁴ Gauss.

We note that larger systems may require flux densities <10⁻²⁰ Gauss.

Dark energy targets may be smaller than neutrinos. If 10⁻⁴⁹ gm is inserted into mc²=BvLq, we get:

(10⁻⁴⁹ gm)(9×10²⁹ cm² sec⁻²)=mc²

BvLq=(B)(3×10⁶ cm² sec⁻²)(30 cm)(1 ab-C),

### Thus,

$$∼ \frac{{10}^{- 28}}{9 \times {10}^{7}} ∼ {10}^{- 36}$$

Gauss. The subtle forces of dark energy regulate the quantum barrier (Wall).

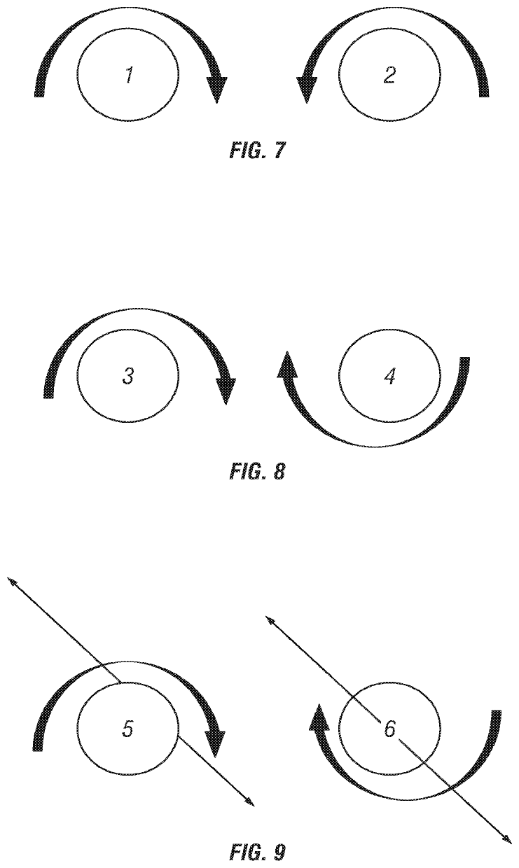

Two particulate masses, 1 and 2, (FIG. 7) reveal opposite spins, opposite rotational dispositions and unlike electric charges, may attract one another due to relative translational motion of black space matter, i.e. dark energy comprising the gravitational field.

Two particulate masses, 3 and 4, (FIG. 8) having the same electric charge, reveal analogous spins/congruent spins, the same rotational dispositions and may repel one another due to opposing relative inertial patterns of black space matter, or dark energy comprising the gravitational field in between said charges.

We note that particulate masses 5 and 6, (FIG. 9) having like electric charges and oppositional black space matter motion in between said charges may be directed to vibrate in relative translational motion with respect to one another in the same directionality, therein induced to do so secondary to photon/phonon transductions provided by resonant magnetic flux densities imbued within the cathode (A) containing deuterium ions and/or other charged species therein cajoling said particles to approach one another while overcoming the quantum barrier and achieving quantum tunneling; thereby producing thermonuclear and/or thermo-particulate fusion energy to be released as heat and converted into electrical energy.

Regulation of vibrational modes for like charges of particles may induce coherent states such that oppositional forces are reduced. These subtle energies are regulating relativism of particulate interactivity all the time. The fusion system achieves ignition through manipulation of other states of matter via “gravity waves.” The flux density range is 10⁻¹⁰ to 10⁻⁴⁰ Gauss.

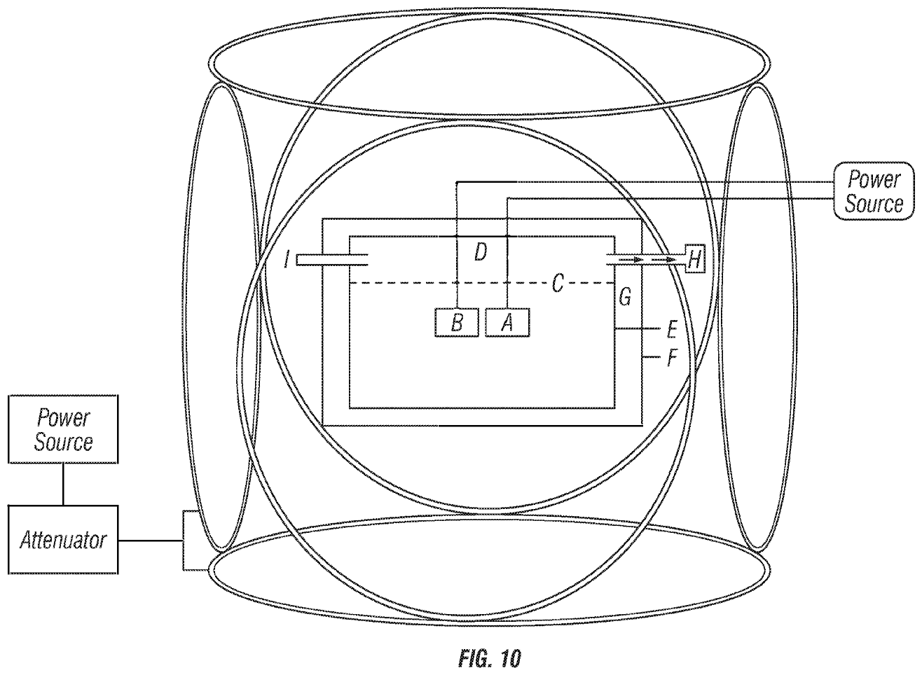

FIG. 10 is a schematic of an example fusion apparatus according to an embodiment of the present disclosure. Utilizing a very simple model including electrodes placed in ocean water and a fenestration above same to permit the flow of heat beyond the system to be converted into electrical energy, we shall fabricate a triple axis coil system to establish an appropriate ambient electromagnetic field.

This field will be calculated using the Jacobson Resonance equation, Mc²=BvLq to establish a photon/phonon transduction wherein the electromagnetic interaction energy produced by the interaction of the ambient EM field and the electrode shall promulgate a gravity wave to return to the phonon field and provide coherent and congruent oscillatory trajectories of deuterium ions such that the ions will be cajoled into moving closer together. This shall be done to overcome the electrostatic repulsion of said ions due to the oppositional flow of dark energy between said ions. The field so calculated will be a close approximation to that necessary to provide the required relative translational motion of said ions, in keeping with outer space magnetic fields as measured by the SQUID in 2006 by NASA ranging from about 10⁻¹¹ gauss to about 10⁻¹⁴ gauss. As I stated earlier, the only explanation for any successful trial in the past has been fortuitous because the ambient EM field was never considered; nor did anyone have a physico-mathematical model to work with in order to ascertain the field necessary to provide resonance.

More specifically, the non-ferrous vessel (E) containing ocean water and/or heavy water (C) will be surrounded by a vacuum (F) and another non-ferrous containment vessel (G) will surround the vacuum (F). Adjustments will be made with fenestrations above the water level on one side (I), to add heavy water as needed, and on the other side, to permit heat leading to a thermocouple (H). The cathode (A) may be palladium or any similar metal of like characteristics, and may be plated and porous to permit deuterons and/or protons to enter the cathode (A). The anode (B) may be made of platinum or other such metals. The electrodes will be connected to a power source and based upon the resistance of the circuit elements including mineralized water, a very weak electrical current will be utilized. It is important to note that a system such as this is analogized to the conditions under which a star is born; as opposed to the conditions speculated to exist within the sun wherein inside the photosphere, the temperatures range from about 23 million degrees Fahrenheit to about 29 million degrees Fahrenheit. Ostensibly, the sun radiates heat and other EM radiant energy to outer space whereas a Tokamak magnetic confinement system blocks such radiation to cool the plasma and prevent ignition.

An example of a reaction that may occur in the sun includes:

₁H¹+₁H¹+¹H¹+₁H¹→₂He⁴+₊₁e⁰+₊₁e⁰+energy

The result of the chain fusion reaction in the sun is the combination of four hydrogen atoms to form a helium atom. The two positrons that may be formed in such a reaction can combine with electrons present in the cathode to mutually annihilate one another producing a pair of gamma rays. The amount of energy equal to the difference between the combined masses of four hydrogen atoms and one helium atom is about 28.3 Mev or about 4.53×10⁻¹² joules. For each proton used in such a reaction 1.13×10⁻¹² joules of energy will be released. Because one gram of protons has about 6.02×10²³ protons, each gram of protons, with respect to this reaction, will release about 6.8×10¹¹ joules of energy. Converting this into electrical energy, we would see 190,000 kilowatt-hours from the reaction of about a gram of protons. This is enough energy to operate a thousand-watt electrical appliance continuously, day and night, for twenty years. Within the cathode, we would provide a photon/phonon transduction promulgating a negative pressure wave of dark matter, i.e. gravitational wave in the quintessence field, to then return to the phonon field of ordinary matter such that the equal intrinsic energy of a proton and/or a deuteron will be mechanically vibrated. This mechanical vibration from a system of dual resonance will regulate the relative translational motion of said protons and/or deuterons such that said motion will oppose the negative pressure wave between two like-charged particles that provide electrostatic repulsion. Thus, the quantum barrier may be overcome as these oppositional forces are overcome, and the nuclei are cajoled or coaxed to move closer together until such time as the gravitational attraction provides fusion.

It is certainly possible that a variety of interactions may occur within the cathode (A) which will produce positrons, positive or negative mesons acting as fermions and or bosons, as well as quesi-particles of fractional electrical charges such as exists in the fractional quantum Hall Effect. Because the triple-axis system regulates the stability of said ions, the fusion process may lead to ignition. Only with the proper ambient magnetic flux densities can such controlled thermonuclear fusion occur, as it does gradually in outer space under conditions of extremely low temperatures and extremely low-level magnetic fields. Because it is proposed that all matter both ordinary and dark matter are ultimately comprised of fundamental magnetic particles, i.e. Leibnitzian monads/magnetic monopoles/elementary electric charges, in conjunction with Einstein and Leibnitzian theory, we note that the relationship between the external field and other states of reality are controllable with magnetic fields. It is obvious that in order to communicate to an atom which is a very small particle, a very weak, resonant, subtle force need be used. Otherwise, we note, that brute forces will influence large collections of atoms only to increase entropic states which ostensibly occurs in strong magnetic confinement test fusion reactors as well as in laser test reactors. The ultimate proposition is that we may in some manner, regulate the constant velocity motion or inertial states of dark matter as it moves within and in between all ordinary matter. This is called inertial electromagnetic induction, or Jacobson Resonance.

Thus, according to some embodiments, the apparatus herein proposed to contain the fundamental system of controlled thermonuclear fusion will be regulated by externally positioned triple axis poloidal coils to regulate the structure of space-time itself, i.e. spin-2 graviton interactions.

### REFERENCES

1. Jacobson, J I. The Application Of Mc²=BVL Coulomb To Plasma Confinement: Ignition In A Fusion Test Reactor. Indian J. THEORETICAL PHYSICS 37: 1-18, 1989
2. Jacobson, Jerry I: STABILIZING PLASMA IN THERMONUCLEAR FUSION REACTORS USING RESONANT LOW LEVEL ELECTROMAGNETIC FIELDS, U.S. Pat. No. 5,198,181, issued Mar. 30, 1993
3. Jacobson J I. Testing for electrogravitational flux quantum circuitry in biological photon-phonon transduction system yields basis for inertial electromagnetic induction and the new particle-wave equation of Jacobson Resonance. OMICS, Engineering J (IER) 2015: http://dx.doi.org/10.4172/2168-9679.1000265
4. Jacobson J. I. A Quantum Theory of Disease including Cancer and Aging. Int. Mol Med. 2016; 3(1): 524-541

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

1-20. (canceled)

21. An apparatus for generating electrical energy using controlled thermonuclear fusion in a shielded environment, the apparatus comprising:
a vessel including electrodes in electrical communication in addition to an external conductive coil arrangement, wherein the vessel is exposed to magnetic fields that pass through the electrodes within an electrolytic system comprising ocean water and/or heavy water that are a source for deuterium gas, deuterons, protons, or neutrons, including but not limited to, quarks, mesons, electrons, gravitons, Higgs Bosons, neutrinos, and anti-neutrinos, wherein a current is applied to the electrolytic system;
multiple power sources, one or more going to the external conductive coil arrangement, and another power source going to the electrolytic system, wherein a flux density (B) of the magnetic field passes through the vessel which contains various particulate masses to be fused, including one or more of deuterium atoms, deuterons and protons, wherein a magnetic flux density of the flux density (B) ranges between about 10⁻⁶ Gauss to about 10⁻²¹ Gauss for resonating deuterons and protons to create a quantum tunnel and/or bridge between said particulate masses through a strong nuclear force carried by gluons to therein overcome the quantum barrier created by electrostatic forces, wherein the deuterons and/or protons fuse, yielding helium and energy, wherein the quantum tunnel and/or bridge must satisfy the equation mc²=BvLq, whereas m is the mass of a particle of the deuterons and/or protons, c is the velocity of light, v is an inertial velocity (constant velocity motion) including the mean orbital velocity of the earth, L is a longest dimension of the electrode and/or the longest dimension of the vessel, and q is 1 ab-coulomb, wherein the intrinsic energy of a target mass will be equal to the magnetic flux density energies provided by the external conductive coil arrangement as well as the electromotive force energy provided by a voltage drop across a cathode, wherein the induction of negative pressure waves from an external field of ordinary matter through a gravitational field are configured to therein provide a phonon of a crystal lattice structure of target masses, which will regulate the flow of dark energy and relative translational motion of particulate masses, including one or more of deuterons and protons, to then produce cajoling of masses to fuse as they overcome electrostatic repulsion; and
wherein the external conductive coil arrangement is configured to induce or cajole deuterium and/or protons to fuse.

22. The apparatus of claim 21, wherein the vessel comprises a non-ferrous vessel containing ocean water and/or heavy water in which the hydrogen has been replaced by deuterium.

23. The apparatus of claim 22, wherein the non-ferrous vessel is surrounded by a vacuum and another non-ferrous containment vessel surrounding the vacuum.

24. The apparatus of claim 22, wherein the electrolysis system includes an anode and cathode that are connected to a power source, wherein the cathode has micropores and is plated to permit deuterons and/or protons to enter the cathode.

25. The apparatus of claim 24, wherein the vessel is configured to permit passage of heat energy provided by the heating of the electrode and heavy water to be converted into electrical energy.

26. The apparatus of claim 24, wherein the coil arrangement includes multiple poloidal and/or solenoidal coils, wherein the directionality of current as well as timing of field polarity shifts are simultaneous and in conformance to said requirements for fusion of ions and/or charged species contained by the cathode having micropores, wherein opposing directionality of current flow in magnetic coil systems may provides a null field within the vessel containing the electrodes.

27. The apparatus of claim 24, wherein a frequency of the magnetic field satisfies the equation
$$f = \frac{10 q B}{2 π m}$$
where f is frequency, wherein magnetic field polarity shifts are under approximately 1 Hz, wherein all extraneous, ambient electromagnetic fields is blocked from interfering with the system described herein.

28. The apparatus of claim 21, wherein the magnetic flux density ranges from about 10⁻¹⁰ Gauss to about 10⁻¹⁵ Gauss.

29. The apparatus of claim 21, wherein the cathode is palladium.
